(19) United States
(12) Patent Application Publication
(10) Pub. No.: US 2023/0372060 A1
(43) Pub. Date: Nov. 23, 2023

(54) GUIDE FOR REVISING DRILLING PATH ON ALVEOLAR BONE

(71) Applicant: Je Won Wang, Daejeon (KR)

(72) Inventor: Je Won Wang, Daejeon (KR)

(21) Appl. No.: 18/028,326

(22) PCT Filed: Sep. 24, 2021
(86) PCT No.: PCT/KR2021/013047

§ 371 Date: Mar. 24, 2023

(30) Foreign Application Priority Data
Sep. 24, 2020 (KR) 10-2020-0123465

(51) Int. Cl. A61C 1/08

(52) U.S. Cl. CPC A61C 1/084

(57) ABSTRACT

The present disclosure relates to a guide for revising a drilling path on the alveolar bone and, more specifically, to a guide for revising a drilling path on the alveolar bone, which is used for guiding to a correctly revised path in a process of new drilling due to a wrong path in the process of drilling a hole to place an implant in the alveolar bone during implant surgery.

### TECHNICAL FIELD

The present disclosure relates to a guide for revising a drilling path on an alveolar bone, and more particularly, to a guide for revising a drilling path on an alveolar bone, which is used for guiding to a correctly revised path in a process of new drilling due to a wrong path in the process of drilling a hole to place an implant in the alveolar bone during implant surgery.

### BACKGROUND ART

In general, in the dental field, restoring a function of teeth by supplementing teeth with artificial products for a large parenchymal loss of teeth, a decreased oral function due to a loss of teeth, or abnormalities in a tooth shape is collectively called prosthetics. An implant, which is one of representative prosthetic treatment technologies, refers to an artificial fixed prosthesis that supplements teeth (more broadly, including a part of bone or gum near a tooth) lost due to disease or accident.

The implant basically includes a prosthetic means having a form in which a tooth shape is imitated so as to replace human teeth, and a fixing means for coupling the prosthetic means to an alveolar bone. The prosthetic means has various additional structures for coupling with the fixing means in addition to the tooth-shaped prosthesis. The fixing means includes a prosthetic attachment part to which the prosthesis is attached, a gingival penetration part that is disposed to penetrate through a gingiva (gum), and an endosseous implantation part that is implanted into alveolar bone to perform fixation, and has various structures, such as several parts being integrally formed or separately formed to be assembled to each other. In general, the endosseous implantation part is formed in the form of a screw in order to be firmly fixed to the alveolar bone for a long time while enduring pressure application of various sizes and directions.

The placement process of fixing the endosseous implantation part of the implant to the alveolar bone is performed in a manner that a hole is first drilled in the alveolar bone in advance to make a place where the endosseous implantation part may be smoothly inserted and then the endosseous implantation part is fitted and fixed to the place. FIG. 1 illustrates the implant placement process, and an upper portion of FIG. 1 illustrates a process of drilling a hole by drilling an alveolar bone, a middle portion of FIG. 1 illustrates a state in which a placement hole (hole for implantation) is completed on the alveolar bone, and a lower portion of FIG. 1 illustrates a state in which an endosseous implantation part is placed.

Meanwhile, in reality, it is quite difficult for an operator to perform such an implantation operation due to various factors such as a very small space in an oral cavity and a treatment area that becomes very slippery due to saliva, blood, etc. In particular, there is a high risk that a drill direction is misaligned as a tip of a drill slips from a surface of a treatment area during drilling. In order to prevent this problem, Korean Patent No. 2009404 (“Drill Guide for Implant Surgery,” Aug. 5, 2019) discloses a drill guide including an insertion hole into which a drill is inserted and a guide part supported leaning against an alveolar bone during drilling. The drill guide according to the related literature may guide a drill in an extension direction of a guide part while the guide part leaning against an alveolar bone since an extension direction of the guide part and an extension direction of an insertion hole are formed in parallel, thereby smoothly drilling an placement hole in a direction parallel to the guide part.

However, when using the drill guide according to the related literature, there are the following problems. Since the guide part is supported leaning against the alveolar bone in the related literature, it is obvious that an angle at which the guide part stands is formed equal to an inclination angle of the surface of the alveolar bone against which the guide part leans. In this case, there is no guarantee that the inclination angle of the surface of the alveolar bone will always be the same as the angle of the placement hole to be drilled, and when the inclination angle of the alveolar bone surface and the desired implant angle are different, it is impossible to form the placement hole in the correct direction. In addition, since the surface of the alveolar bone is surrounded by gingival (gum) tissue, the guide part actually leans against the gingival surface. However, since a thickness of the gingiva is non-uniform and a material of the gingiva is soft, and an outer surface of the gingiva is even slippery due to blood and saliva, it is difficult to guarantee that the guide part may be well supported on the gingival surface in a desired direction or position. That is, since the guide part is substantially supported by the gingiva, the risk that the placement hole is not formed in a desired direction or position also increases.

In this way, when the placement hole is not formed in the correct direction or position, a new placement hole needs to be formed in an unavoidable corrected path. When multiple holes are generated as the alveolar bone is shaved off whenever such revision is performed, it is natural that the stability will greatly decrease after the implant surgery is completed. In addition, when the alveolar bone is excessively shaved off due to repetitive revision work, there may not be enough alveolar bone left to form a placement hole later. Therefore, even if the placement hole formation operation is incorrect until once, the revision operation needs to be performed at once without failing.

However, as described above, it was difficult to form the placement hole in the desired direction and position only with the conventional device and technology due to various constraints (alveolar bone inclination, surface condition, etc.), and it is difficult to guarantee that the placement hole may be formed in the desired direction and position even during the revision operation because the operation is performed under the same limited circumstances even during the revision operation.

### RELATED ART DOCUMENT

### Patent Document

1. Korean Patent No. 2009404 (“Drill Guide for Implant Surgery,” Aug. 5, 2019)

### DISCLOSURE

### Technical Problem

An object of the present disclosure provides a guide for revising a drilling path on the alveolar bone and, more specifically, a guide for revising a drilling path on the alveolar bone, which is used for guiding to a correctly revised path in a process of new drilling due to a wrong path in the process of drilling a hole to place an implant in the alveolar bone during implant surgery.

### Technical Solution

In one general aspect, a guide 100 for revising a drilling path on an alveolar bone that guides a drill 550 to form a correctly revised placement hole 500 by revising the direction or position after formation of an erroneous placement hole 505 in a wrong direction or position in a process of drilling an implant placement hole in the alveolar bone, includes: a body part 110 that includes an endosseous insertion part 111 inserted into and supported by the erroneous placement hole 505 and an intraoral exposed part 112 exposed into an oral cavity; and at least one guide part 120 that has a predetermined direction or position and is formed in a form of a straight hole penetrating through the body part 110 to guide the drill 550.

In this case, the guide part 120 may be formed so that the direction or position of the guide part 120 is different from an extension direction or formation position of the endosseous insertion part 111 and the erroneous placement hole 505. In this case, the guide part 120 may be formed so that the direction or position of the guide part 120 is the same as the extension direction or formation position of the revised placement hole 500.

In addition, one to four guide parts 120 having different directions or positions may be formed on the body part 110 so that at least one guide part 120 is disposed parallel to the revised placement hole 500 while the endosseous insertion part 111 is inserted into the erroneous placement hole 505.

In addition, when the intraoral exposed part 112 is an upper side of the body part 110 and the endosseous insertion part 111 is a lower side of the body part 110, one end of the guide part 120 may be formed on the intraoral exposed part 112, and the other end of the guide part 120 may be disposed below one end on the body part 110 so that the drill 550 is formed to be guided while being inserted from one end to the other end of the guide part 120.

In addition, the guide part 120 may have a diameter equal to or greater than that of the drill 550.

In addition, the body part 110 may be integrated with the endosseous insertion part 111 and the intraoral exposed part 112. In this case, the body part 110 may be formed so that a cross-sectional area of the intraoral exposed part 112 is larger than that of the endosseous insertion part 111.

### Advantageous Effects

According to the present disclosure, it is possible to stably and accurately guide a drill so that a revision operation may be correctly performed at once in a process of newly drilling a hole due to a wrong path in a process of drilling a hole to place an implant in the alveolar bone during an implant surgery. Since the conventional drill guide is mostly supported against an alveolar bone, the guide itself is distorted or not supported firmly due to an inclination angle of the alveolar bone, a non-uniform thickness of a gingiva attached to an outside of the alveolar bone, or a slippery surface condition due to blood or saliva, etc., so there is a problem such as the distorted disposition of the guide during operation. However, according to the present disclosure, since a device is supported in a hole that was drilled incorrectly just before a revision operation, it is possible to secure a firm support force, so there is a great effect of fundamentally eliminating the risk that the guide is distorted from the beginning, the risk that the guide is distorted during operation, or the like.

### BRIEF DESCRIPTION OF THE DRAWINGS

FIG. 1 is a diagram illustrating an implant placement process.

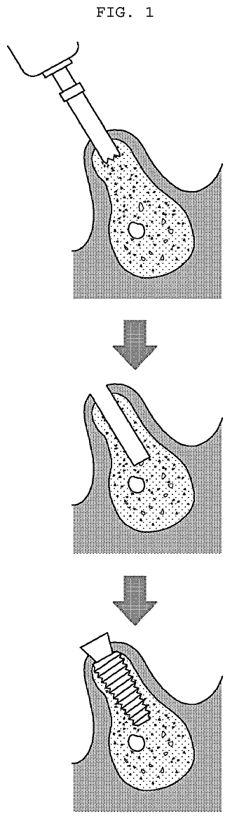

FIG. 2 is a diagram illustrating a guide for revising a drilling path on an alveolar bone according to an embodiment of the present disclosure.

FIG. 3 is a diagram illustrating an implant placement process including a path revision process using the guide for revising a drilling path on an alveolar bone according to the embodiment of the present disclosure in FIG. 2.

FIG. 4 is a diagram illustrating a guide for revising a drilling path on an alveolar bone according to another embodiment of the present disclosure.

FIG. 5 is a diagram illustrating an implant placement process including a path revision process using the guide for revising a drilling path on an alveolar bone of according to the embodiment of the present disclosure in FIG. 4.

[Detailed Description of Main Elements]

| | |
|---|---|
| 100: Guide for revising drilling path | |
| on alveolar bone | |
| 110: Body part | |
| 111: Endosseous insertion part | 112: Intraoral exposed part |
| 120: Guide part | |
| 101: Parallel pin | 102: Guide pin |
| 500: Revision placement hole | 505: Erroneous placement hole |

### BEST MODE

Hereinafter, a guide for revising a drilling path on an alveolar bone according to the present disclosure having the above configuration will be described in detail with reference to the accompanying drawings.

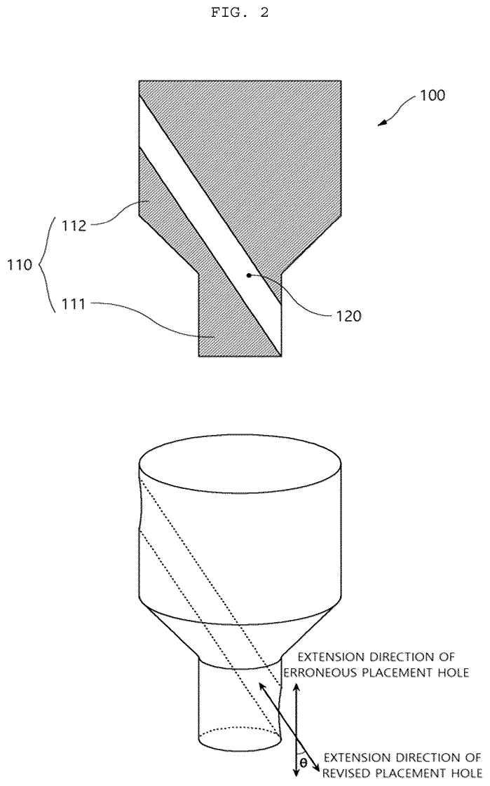

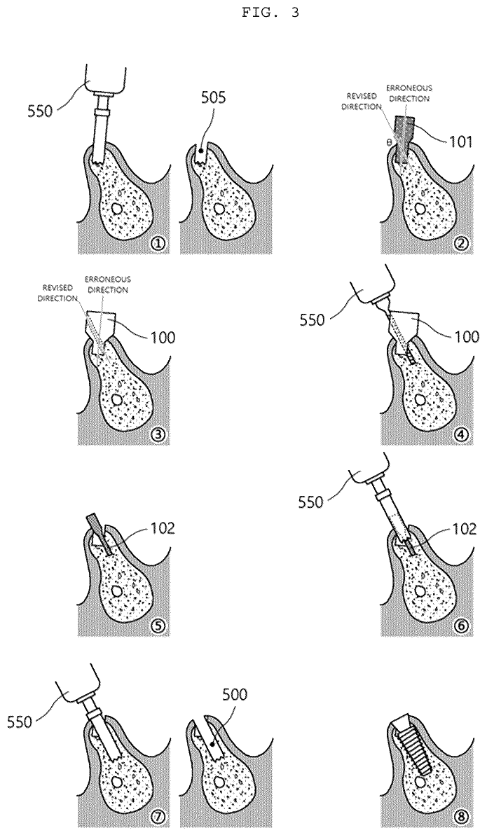

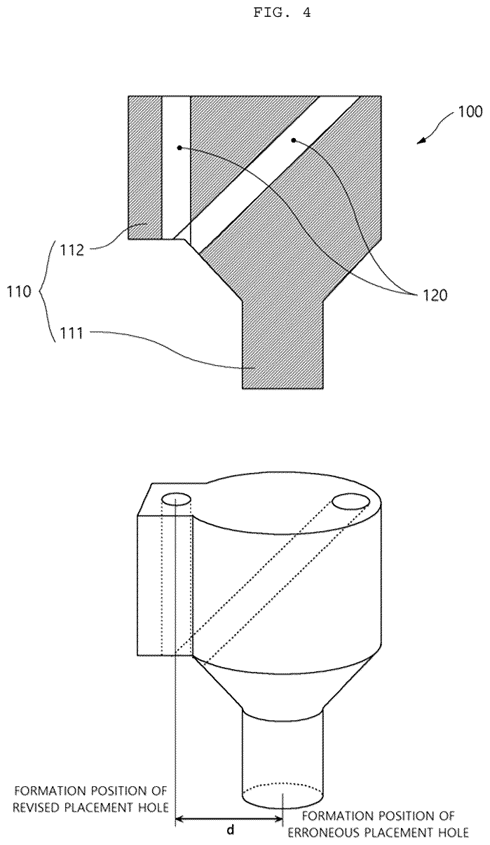

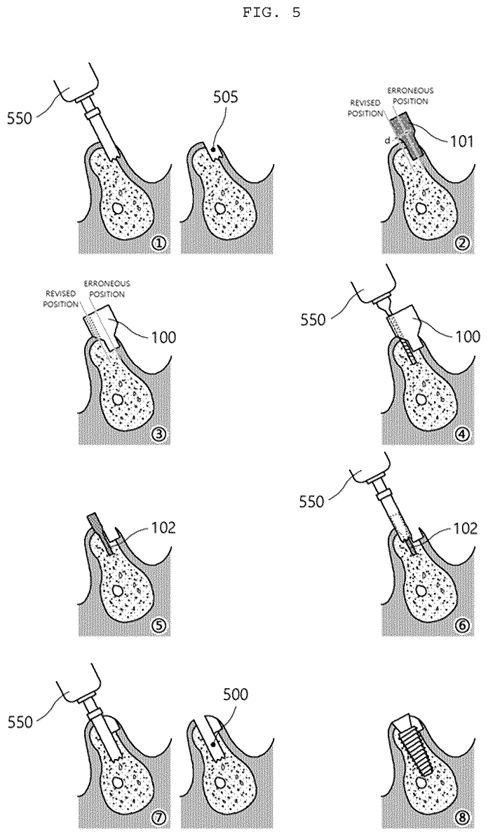

A guide 100 for revising a drilling path on an alveolar bone is to guide a drill 550 to form a correctly revised placement hole 500 by revising a direction or position after formation of an erroneous placement hole 505 in a wrong direction or position in a process of drilling an implant placement hole in the alveolar bone. First, FIG. 2 illustrates a guide for revising a drilling path on an alveolar bone according to an embodiment of the present disclosure, and FIG. 3 illustrates an implant placement process including a path revision process using the guide for revising a drilling path on an alveolar bone of according to the embodiment of the present disclosure in FIG. 2. In addition, FIG. 4 illustrates a guide for revising a drilling path on an alveolar bone according to another embodiment of the present disclosure, and FIG. 5 illustrates an implant placement process including a path revision process using the guide for revising a drilling path on an alveolar bone of according to the embodiment of the present disclosure in FIG. 4. As illustrated in FIGS. 2 and 4, the guide 100 for revising a drilling path on an alveolar bone according to the present disclosure includes a body part 110 and a guide part 120.

As illustrated in FIGS. 2 and 4, the body part 110 includes an endosseous insertion part 111 and an intraoral exposed part 112. As can be intuitively seen from its name, the endosseous insertion part 111 is a part inserted into the alveolar bone. In this case, in the guide 100 for revising a drilling path on an alveolar bone of the present disclosure, the endosseous insertion part 111 is inserted into the erroneous placement hole 505 to be supported. The intraoral exposed part 112 is a part exposed into an oral cavity, and may have a different diameter from that of the endosseous insertion part 111 as illustrated. As such, when the diameters of the endosseous insertion part 111 and the intraoral exposed part 112, respectively, are different from each other, two parts may be connected to be stepped. However, since an outer surface of the alveolar bone is covered with gingival soft tissue, it is highly likely that a connection portion between the endosseous insertion part 111 and the intraoral exposed part 112 is disposed at a position of the gingival soft tissue. Therefore, it is preferable that the connection portion between the endosseous insertion part 111 and the intraoral exposed part 112 has a gentle shape as illustrated so that the gingival soft tissue is not damaged unnecessarily.

First, the shape of the body part 110 will be described below. It is preferable that the body part 110 is once integrated with the endosseous insertion part 111 and the intraoral exposed part 112, as illustrated. In fact, the guide 100 for revising a drilling path on an alveolar bone is so small that it may be disposed in a space between teeth, and specifically, is so small that it has a size of about several tens of mm. In addition, since the role and purpose of the guide 100 itself for revising a drilling path on an alveolar bone is to correctly guide the drill 550 in the process of drilling the alveolar bone, it is natural that the body part 110 should be rigid enough to withstand forces applied in various directions by the drill 550. Considering these various situations, it is not necessary for the body part 110 to be formed by assembling several parts, and therefore, it is most preferable that the body part 110 is integrally formed by molding one lump into a desired shape.

Meanwhile, (as will be described in more detail later), the size or shape of the endosseous insertion part 111 is limited in relation to the drill 550, and it is preferable that the intraoral exposed part 112 is formed larger than the endosseous insertion part 111 when considering the ease of work such as securing a field of view. Specifically, the cross-sectional area of the intraoral exposed part 112 may be larger than that of the endosseous insertion part 111. In addition, FIG. 2 illustrates that a cross section of the intraoral exposed part 112 is circular, and FIG. 4 illustrates that a cross section of the intraoral exposed part 112 has an asymmetrical shape in which a square is added to a circle, In addition, the cross section of the intraoral exposed part 112 may be formed in any shape such as an ellipse, a convex polygon, a concave polygon, a symmetrical shape, or an asymmetrical shape.

The guide part 120 is a part that substantially guides the drill 550, and is specifically formed in the form of a straight hole penetrating through the body part 110. As illustrated in FIG. 2, one guide part 120 may be formed on the body part 110, or as illustrated in FIG. 4, a plurality of guide parts 120 may be formed on the body part 110. The guide part 120 is designed to have a predetermined direction or position, if necessary. A method of determining the direction or position of the guide part 120 will be described in more detail based on the implant placement process including the path revision process of FIGS. 3 and 5.

With reference to FIGS. 3 and 5, the implant placement process including a path revision process using the guide for revising a drilling path on an alveolar bone of according to the present disclosure will be described step by step as follows. The case where there is an error in the direction in FIG. 3 and the case where there is an error in the position in FIG. 5 are different, but the steps themselves are the same, so they will be described collectively below.

Step \textcircled{1}: The alveolar bone is drilled to a slight depth (e.g., about 2 to 3 mm) using the drill 550. When the hole formed in this case is not formed in the desired direction or position, that is, when the direction or position is the erroneous placement hole 505, the revision operation is required. In this case, the guide 100 for revising a drilling path on an alveolar bone of the present disclosure will be used.

Step \textcircled{2}: First, the parallel pin 101 is inserted into the erroneous placement hole 505 formed in step \textcircled{1} and the direction and position of the erroneous placement hole 505 are accurately confirmed through cone beam computed tomography (CBCT) shooting or the like. FIG. 3 illustrates the case where there is an error in the direction, the direction of the parallel pin 101 is marked as “erroneous direction,” and the direction in which the original implant is to be placed, that is, the direction to be revised, is marked as “revised direction.” FIG. 5 illustrates a case where there is an error in the position, the position of the parallel pin 101 is marked as “erroneous position,” and the position where the original implant is to be placed, that is, the position to be revised, is marked as “revised position.”

Step \textcircled{3}: Since the angle between the erroneous direction/revised direction or the distance between the erroneous position/revised position was confirmed in step \textcircled{2}, the guide 100 for revising a drilling path on an alveolar bone on which the corresponding guide part 120 is formed is selected, and the selected guide 100 is disposed in the erroneous placement hole 505. As described above, the guide part 120 is formed in the form of the straight hole penetrating through the body part 110. In this case, it may be considered how to know in advance which direction or position an error will occur in the drilling process, but as described above, the implant surgery operation is an operation performed in a very narrow, very limited space between teeth, and even if an error occurs, a range of the error is somewhat predictable. In particular, in the case of the position, since a distance d between the erroneous position and the revised position is made within the range of several mm, for example, several guides 100 for revising a drilling path on an alveolar bone are prepared in advance so that the distance d between the erroneous position/revised position is 1 mm/2 mm/3 mm/4 mm/5 mm, and when an error occurs, an appropriate guide may be selected and used. That is, for example, when the distance d between the erroneous position/revised position is 2.7 mm, the guide 100 for revising a drilling path on an alveolar bone, which has a length of about 3 mm, may be selected and used. Likewise in the case of the direction, for example, it is sufficient to prepare several guides 100 for revising a drilling path on an alveolar bone in advance so that an angle θ between the erroneous direction/revised direction is 10°/20°/30°/ . . . /90°.

When the endosseous insertion part 111 of the guide 100 for revising a drilling path on an alveolar bone is inserted into and supported by the erroneous placement hole 505, it is natural that the endosseous insertion part 111 is formed in the same direction and position as the erroneous placement hole 505. Since the guide part 120 is a hole for guiding a drill to revise an error, it is natural that the direction or position of the guide part 120 is formed differently from the extending direction or formation position of the endosseous insertion part 111 and the erroneous placement hole 505. At the same time, in order to perform the correctly revised operation, the direction or position of the guide part 120 needs to be formed identically to the extension direction or formation position of the revised placement hole 500. As described above, in the present disclosure, in a state in which the endosseous insertion part 111 is inserted into the erroneous placement hole 505, the guide part 120 is disposed parallel to the revised placement hole 500.

Meanwhile, as described above, the guide unit 120 is formed by determining the angle θ between the erroneous direction and the revised direction or the distance d between the erroneous position and the revised position in advance. In this case, when only one guide part 120 is formed in one body part 110, the number of types of the guide 100 for revising a drilling path on an alveolar bone is too large, so there is a risk of causing confusion to an operator. In order to solve this problem, the guide 100 for revising a drilling path on an alveolar bone has a plurality of guide parts 120 formed on one body part 110, as illustrated in the embodiment of FIG. 4. However, from another point of view, as described above, since the guide 100 for revising a drilling path on an alveolar bone is very small to the extent of having a size of several tens of mm, when too many guide parts 120 are formed in one body part 110, there is a risk that the rigidity of the guide 100 will be significantly weakened. Considering these various matters, it is preferable that one to four guide parts 120 having different directions or positions are formed on the body part 110. In this case, in the state in which the endosseous insertion part 111 is inserted into the erroneous placement hole 505, at least one guide part 120 may be disposed parallel to the revised placement hole 500.

Step \textcircled{4}: As described above, in a state in which the endosseous insertion part 111 is inserted into the erroneous placement hole 505, the drill 550 is used to drill the alveolar bone along the guide part 120 while at least one guide part 120 is disposed parallel to the revised placement hole 500. That is, as illustrated in the drawings, in step \textcircled{4}, the drilling operation is performed while being naturally guided by the guide part 120 by inserting the tip of the drill 550 into the guide part 120.

In this case, in step \textcircled{1}, a tip suitable for drilling a placement hole is mounted at the end of the drill 550, while in step \textcircled{4}, a tip suitable for drilling a hole suitable for the guide pin 102 that is thinner than the placement hole is mounted at the end of the drill 550 (the guide pin 102 will be described in more detail in step \textcircled{5}). Of course, a separate pin-drill may be used, but in general, since almost all drills are manufactured so that the tip at the end may be replaced by diameter and shape, one drill 550 is used, but replacing only the tip at the end appropriately according to the steps will further improve the smoothness of the operation. In this way, in a state in which the endosseous insertion part 111 is inserted into the erroneous placement hole 505, since the drill 550 may be inserted into the guide part 120 only when the guide part 120 comes into the operator's field of view, it is natural that one end of the guide part 120 is formed in the intraoral exposed part 112. Specifically, when the intraoral exposed part 112 is the upper side of the body part 110 and the endosseous insertion part 111 is the lower side of the body part 110, it is illustrated that one end of the guide part 120 is formed on the upper side of the intraoral exposed part 112 in the embodiment of FIG. 2, and both are formed on the upper surface of the intraoral exposed part 112 in the embodiment of FIG. 4. In addition, the drill 550 guided along the guide part 120 comes in contact with the alveolar bone when the other end of the guide part 120 is disposed below one end on the body part 110, thereby performing the drilling operation. Specifically, it is illustrated that the other end of the guide part 120 is formed on the endosseous insertion part 111 in the embodiment of FIG. 2 and is formed on the lower end of the intraoral exposed part 112 in the embodiment of FIG. 4. In summary, one end of the guide part 120 only needs to be formed on the upper side of the intraoral exposed part 112 so that the operator's field of view is secured, and the other end of the guide part 120 may be formed to be disposed only a lower side than one end according to the predetermined direction or position of the guide part 120. In this way, the drill 550 is naturally guided while being inserted from one end to the other end of the guide part 120, so that drilling operation in the revised direction or revised position may be smoothly performed.

Step \textcircled{5}: As illustrated, the guide pin 102 is once inserted and disposed at the position drilled in the revised direction or revised position. When drilling the placement hole, the tip inserted into the drill 550 is formed in a hollow cylindrical shape and has a saw blade formed at the end, so the alveolar bone may be cut in a cylindrical shape. Korean Patent Publication No. 1192662 (“Drill for Implant Surgery,” Oct. 12, 2012) describes such a drill tip shape well. The guide pin 102 is for guiding the drill 550 equipped with a tip having such a shape.

Step \textcircled{6}: In a state where the guide pin 102 is disposed, the drill 550 is guided by the guide pin 102 in the manner that the hollow cylindrical drill tip moves while being covered with the guide pin 102 in step \textcircled{6} as illustrated in the drawing. In this way, by using the guide pin 102, the drilling operation in the revised direction or revised position may be smoothly performed.

The guide part 120 of the guide 100 for revising a drilling path on an alveolar bone is made to correspond to the diameter of the drill tip used in step \textcircled{1} or step \textcircled{6}, that is, a drill tip having a diameter corresponding to the diameter of the placement hole. By doing so, the process of drilling for arranging the guide pin 102 (step \textcircled{4}), the process of disposing the guide pin 102 (step \textcircled{5}), and the process of drilling the placement hole by guiding the drill 550 by the guide pin 102 (step \textcircled{6}) may be replaced with one [process of drilling the placement hole along the guide part]. Of course, in this case, there is no need to perform an operation while replacing the tip of the drill 550 with the tip/pin drill tip for drilling the placement hole.

However, in this case, the diameter of the guide part 120 needs to be made large enough to correspond to the diameter of the placement hole. As described several times above, the size of the guide 100 for revising a drilling path on an alveolar bone is very small, and therefore, as the guide part 120 in the form of the through hole is formed, it is inevitable that the rigidity of the guide 100 is significantly reduced. However, when the diameter of the guide part 120 is excessively large, there is a risk that the guide 100 for revising a drilling path on an alveolar bone may not secure enough rigidity to sufficiently support and guide the drill 550. Considering this point, the guide part 120 has a diameter corresponding to the diameter of the guide pin 102, which is much smaller than the diameter of the placement hole, so, only a small diameter hole for inserting the guide pin 102 into the alveolar bone is drilled by the guide 100 for revising a drilling path on an alveolar bone, and when actually drilling the placement hole, the drill 550 is guided using the guide pin 102 instead of the guide 100 for revising a drilling path on an alveolar bone. In this way, the rigidity of the guide 100 for revising a drilling path on an alveolar bone may be sufficiently secured, and at the same time, the guidance to the desired revised path may be smoothly realized.

Step \textcircled{7}: state in which the hollow cylindrical tip of the drill 550 completely covers the guide pin 102 is illustrated, that is, in this step, the drill 550 proceeds to a desired depth and the formation of the revised placement hole 500 is completed. As described in detail above, since the drill 550 proceeds in a state in which the guide 100 for revising a drilling path on an alveolar bone is firmly guided to the revised path, the placement hole made in this step becomes the revised placement hole 500 made accurately in the original desired direction and position.

Step \textcircled{8}: A state in which the endosseous implantation part of the implant is placed in the revised placement hole 500 made through the steps described above is illustrated. Since the direction and position of the revised placement hole 500 are made exactly as originally desired, the direction and position of the implant may also be accurately formed as desired.

Even if the erroneous placement hole 505 is formed in the wrong direction or position during the implant placement hole drilling process, by using the guide 100 for revising a drilling path on an alveolar bone of the present disclosure, the drill 550 is correctly guided through the revised path in which the direction or position is revised, so the revised placement hole 500 having the revised direction or position may be smoothly formed.

The present disclosure is not limited to the abovementioned exemplary embodiments, but may be variously applied. In addition, the present disclosure may be variously modified by those skilled in the art to which the present disclosure pertains without departing from the gist of the present disclosure claimed in the claims.

### INDUSTRIAL APPLICABILITY

According to the present disclosure, there is a great effect of stably and accurately guiding a drill so that an alveolar bone drilling revision operation may be performed correctly at once during implant surgery. Therefore, it is possible to greatly improve a success effect of implant surgery by preventing unnecessary additional damage to the alveolar bone during the revision operation.

1. A guide for revising a drilling path on an alveolar bone that guides a drill to form a correctly revised placement hole by revising the direction or position after formation of an erroneous placement hole in a wrong direction or position in a process of drilling an implant placement hole in the alveolar bone, the guide comprising:
a body part that includes an endosseous insertion part inserted into and supported by the erroneous placement hole and an intraoral exposed part exposed into an oral cavity; and
at least one guide part that has a predetermined direction or position and is formed in a form of a straight hole penetrating through the body part to guide the drill.

2. The guide of claim 1, wherein the guide part is formed so that the direction or position of the guide part is different from an extension direction or formation position of the endosseous insertion part and the erroneous placement hole.

3. The guide of claim 2, wherein the guide part is formed so that the direction or position of the guide part is the same as the extension direction or formation position of the revised placement hole.

4. The guide of claim 3, wherein one to four guide parts having different directions or positions are formed on the body part so that at least one guide part is disposed parallel to the revised placement hole while the endosseous insertion part is inserted into the erroneous placement hole.

5. The guide of claim 1, wherein, when the intraoral exposed part is an upper side of the body part and the endosseous insertion part is a lower side of the body part, one end of the guide part is formed on the intraoral exposed part, and the other end of the guide part is disposed below one end on the body part so that the drill is formed to be guided while being inserted from one end to the other end of the guide part.

6. The guide of claim 1, wherein the guide part has a diameter equal to or greater than that of the drill.

7. The guide of claim 1, wherein the body part is integrated with the endosseous insertion part and the intraoral exposed part.

8. The guide of claim 7, wherein the body part is formed so that a cross-sectional area of the intraoral exposed part is larger than that of the endosseous insertion part.
